(19) United States
(12) Patent Application Publication
(10) Pub. No.: US 2007/0079510 A1
(43) Pub. Date: Apr. 12, 2007

(54) Orbital triple head electric shaver

(76) Inventors: Jeremiah Michael Hannan, San Rafael, CA (US); Thomas P. Hannan, San Rafael, CA (US)

Correspondence Address: JERRY HANNAN, 248 McNEAR DRIVE, SAN RAFAEL, CA, 94901, US

(21) Appl. No.: 11/407,175

(22) Filed: Apr. 20, 2006

Related U.S. Application Data
(60) Provisional application No. 60/679,080, filed on May 9, 2005.

(51) Int. Cl. B26B 19/14

(52) U.S. Cl. 30/43.6

(57) ABSTRACT

A triple head electric shaver with enlarged holes in the shaver head to permit the cutters and foils to move in an orbital or circular type motion within the enlarged holes in the shaver head when the cutters are rotating The shafts that drive the cutters having offset tips that engage the cutters sockets in the shaver head Long axle shafts secured rigidly in the shaver body allow the cutter drive shafts to rotate without wobbling A leg on the cutter foils engaged loosely in a slot in the shaver head prevents the foils from rotating when the cutters rotate As an alternative method; offsetting the sockets in the cutters instead of offsetting the tips on the drive shafts may also be used.

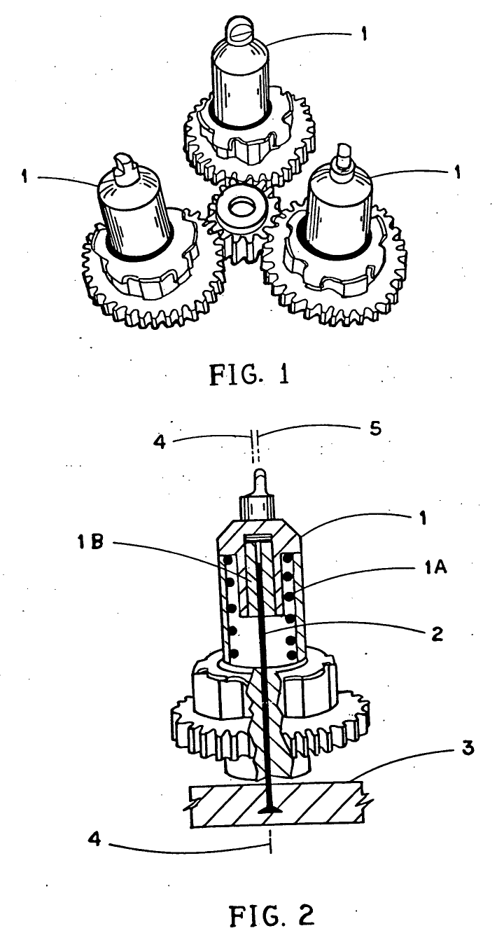

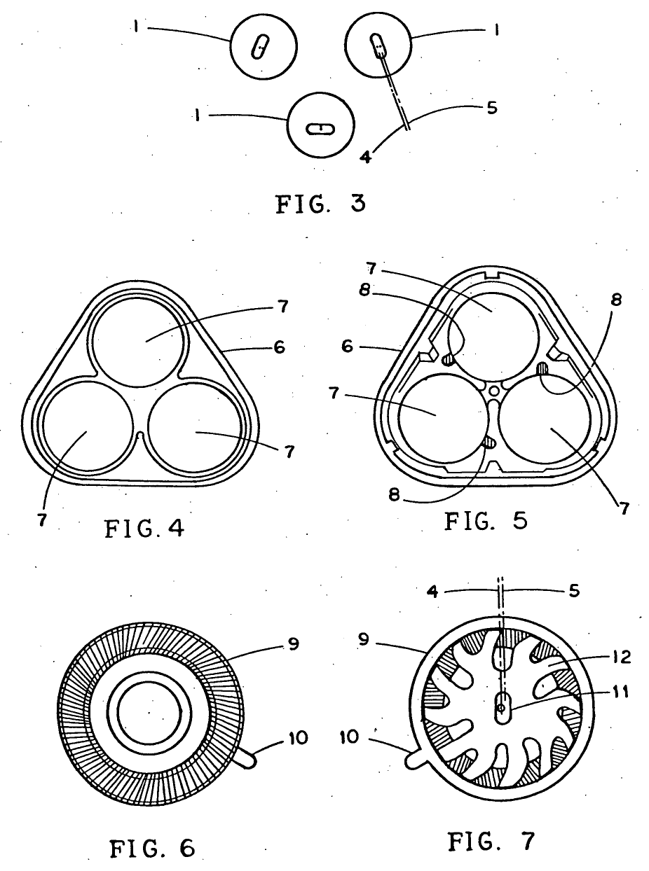

### SUMMARY OF THE INVENTION

1. Field of the Invention

Rotary electric shavers having a plurality of planetary, rotating cutting heads.

The present invention arose as a result of the absence in prior art of a means of producing an orbiting or circular type motion of the cutters and foils in an electric shaver with rotary cutting heads that are in planetary motion.

In current practice the cutter foils are stationary when the cutters are rotating. In the present invention the cutters and foils move in a circular or orbital type of motion in the shaver head when the cutters are rotating.

The subject of this patent application is an improved triple-head electric shaver. The orbital electric shaver is made up of the following parts, namely, drive shafts with bushings in their upper ends and offset tips, enlarged holes in the caps, grooves or slots in the underside of the caps, foils with leg attached, long axle shafts in shaver body, standard cutters.

The drive shafts contain bushings that ride on rigid axle pins and have offset engagement tips that engage the sockets of the cutters. The cap has enlarged holes to permit the foil and cutter assemblies to move in an orbital motion within the cap opening.

Grooves or slots in the underside of the cap to accept the leg on the foil, thus preventing the foil from spinning with the cutters.

Long axle shafts secured rigidly in the shaver body.

Cutters with their sockets in the center of the cutter.

The subject of this patent application may be more generally described as follows: The subject of this patent application is an improved triple-head electric shaver. The orbital electric shaver is an assembly made up of the following parts, namely, a means for driving the cutters, a means for having the cutter and foil assemblies move within their openings, a means to prevent the foil assemblies from rotating with the cutters. The means for preventing the foils from rotating preferably employs a leg on the foil that fits loosely into a slot in the cap The means for driving the cutters includes an electric motor, a gear assembly, drive shafts and means to engage the cutters. Means to hold the drive shafts stable when rotating. The means to hold the drive shafts stable when rotating preferably employs rigid axle shafts firmly secured to the shaver body upon which the drive shafts rotate. Means to allow the drive shafts to firmly engage the sockets of the cutters. The means to allow the drive shafts to firmly engage the cutters preferably employs a spring and a sliding member of the drive shaft that presses firmly against the cutters holding them comfortably in the foils and whose sliding member fits into the body base.

In operation the orbital electric shaver has holes in the cap preferably 1.5 millimeter larger in diameter than the cutter-foil assembly. The tips or drive ends of the drive shafts that engage the cutters are preferably offset on the drive shafts 0.5 millimeter from center. The drive shafts rotating on fixed shafts in the shaver body will cause the cutter-foil assembly to move in an orbital motion within the enlarged holes in the cap, resulting in a faster closer shave.

1) The combination with a triple head electric shaver wherein the diameter of the holes in the shaver head also referred to as the cap are sufficiently larger than the diameters of the foils to permit the foils and cutters to move in an orbital or circular type motion within the holes of the shaver head

2) The combination with a triple head electric shaver with means to provide for the foils and the cutters in the shaver head to move in an orbital or circular type motion without the foils spinning with the cutters.

3) The means referred to in claim (2) include offset tips on the ends of the drive shafts that engage the cutters.

4) The drive shafts referred to in dependent claim (3) rotate on rigidly mounted axle pins in the shaver body

5) The offset tips on the end of the drive shafts referred to in dependent claim (3) engage the cutters and as the drive shafts rotate they cause the cutters together with the foils to move in a circular or orbital type motion within the enlarged holes in the shaver head.

6) The combination with a triple head electric shaver wherein the cutters alternatively have offset sockets that engage the tips of the drive shafts.
